(19) United States
(12) Patent Application Publication
(10) Pub. No.: US 2023/0415802 A1
(43) Pub. Date: Dec. 28, 2023

(54) EZ TRANSPORTER

(71) Applicant: John Mason, JR., Petersburg, VA (US)

(72) Inventor: John Mason, JR., Petersburg, VA (US)

(21) Appl. No.: 17/846,006

(22) Filed: Jun. 22, 2022

(51) Int. Cl. B62B 5/00; B62B 3/00; B62B 5/06

(52) U.S. Cl. CPC B62B 5/0069; B62B 3/00; B62B 5/067

(57) ABSTRACT

A transporter for transporting wheeled items. The transporter has a body and a front wheel coupled to a front end of the body. The transporter has a back-wheel coupled to a back-end of the body. The transporter has a handle assembly for steering and controlling the transporter and the handle assembly is coupled to the front end of the body. The transporter has a coupler assembly that is coupled to a back-side of the body. The coupler assembly for coupling to the item to be transported. The back-wheel further has an axel with a first end and a second end. The back-wheel has one or more wheels where the first of the wheels is coupled to the first side of the axle and a second of the wheels is coupled to the second side of the axle. The back-wheel has a shaft coupled to a midpoint of the axle. The transporter has a plurality of sensors for determining near by objects and are useful in proper positioning of the transporter for use.

### FIELD OF THE INVENTION

This invention relates to antennae. More particularly, it relates to antenna mounting systems.

### BACKGROUND

Transport or transportation is the movement of humans, animals and goods from one location to another. In other words, the action of transport is defined as a particular movement of an organism or thing from a point A to the Point B.

Transport modes include air, land (rail and road), water, cable, pipeline and space. The field can be divided into infrastructure, vehicles and operations. Transport is important because it enables trade between people, which is essential for the development of civilizations.

A warehouse is a building for storing goods. Warehouses are used by manufacturers, importers, exporters, wholesalers, transport businesses, customs, etc. They are usually large plain buildings in industrial parks on the outskirts of cities, towns or villages.

They usually have loading docks to load and unload goods from trucks. Sometimes warehouses are designed for the loading and unloading of goods directly from railways, airports, or seaports. They often have cranes and forklifts for moving goods, which are usually placed on ISO standard pallets loaded into pallet racks. Stored goods can include any raw materials, packing materials, spare parts, components, or finished goods associated with agriculture, manufacturing, and production.

Some warehouses are completely automated, and require only operators to work and handle all the task. Pallets and product move on a system of automated conveyors, cranes and automated storage and retrieval systems coordinated by automation software. These systems are often installed in refrigerated warehouses where temperatures are kept very cold to keep the product from spoiling.

This is especially true in electronics warehouses that require specific temperatures to avoid damaging parts. Automation is also common where land is expensive, as automated storage systems can use vertical space efficiently. These high-bay storage areas are often more than 10 meters (33 feet) high, with some over 20 meters (65 feet) high. Automated storage systems can be built up to 40 m high.

For those modes of transport that are not automated, the equipment can be bulky, hard to use, specialized, etc. Therefore, there is a need for an apparatus that can be used to move product and cargo without specialization or overabundance of training. Further, there is a need for an easy to use apparatus to move product and cargo easily and without straining workers.

### BRIEF DESCRIPTION OF THE DRAWINGS

FIG. 1 is an illustrated view of an exemplary transporter.

FIG. 2 is an illustrated view of the back-wheel of the transporter shown in FIG. 1.

FIG. 3 is an illustrated view of the front-wheel of the transporter shown in FIG. 1.

FIG. 4 is an illustrated view of the handle assembly of the transporter shown in FIG. 1.

FIG. 5 is an illustrated view of a coupler for the transporter shown in FIG. 1.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

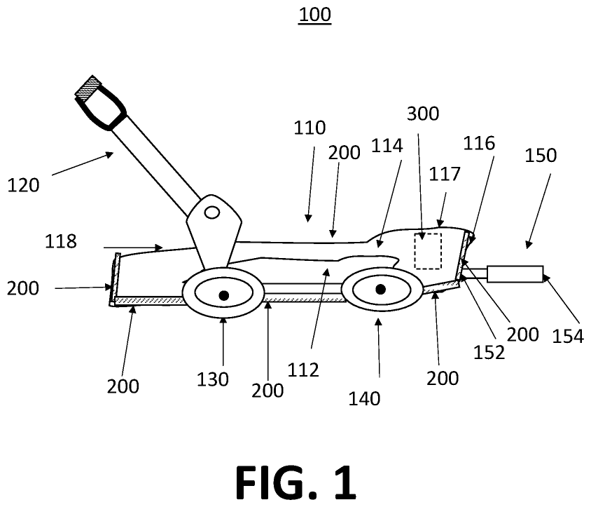

Referring to FIG. 1, an exemplary transporter 100 for moving cargo and products is presented. The transporter 100 is useful for transporting equipment that is on wheels. The transporter 100 is useful to relieve an operator from excessive effort and training in order to be able to operate the transporter 100. The transporter 100 is preferably automatic and is configured to determine objects such that it slows down and adjusts to the be coupled to a portable wheeled vehicle, such as a trailer, a cart, etc.

The transporter 100 is preferable of an oval shape, but may be other shapes as well such as rectangular, oblong, square, trapezoidal, etc. The transporter 100 is preferably one and one-half (1.5) feet in height, but other heights may be chosen as well such as two (2) feet, one (1) foot, one-half (0.5) feet, etc. The transporter 100 is preferably two and one-half (2.5) feet in length, but other lengths may be chosen as well such as two (2) feet, one (1) foot, five (5) feet, etc.

The transporter 100 is preferably two (2) feet in depth, but other depths may be chosen as well such as two and one-half (2.5) feet, one (1) foot, five (5) feet, etc. The transporter 100 is preferably made of a metal material such as steel, aluminum, etc. but may be made of materials, such as hard plastic, high-density polyethylene (HDPE), PVC, etc.

The transporter 100 has a body 110, a handle assembly 120, a back-wheel 130, a front wheel 140 and a coupler assembly 150. The body 110 of the transporter 100 is preferably made of a metal material such as steel, aluminum, etc. but may be made of materials, such as hard plastic, high-density polyethylene (HDPE), PVC, etc.

The body 110 of the transporter 100 is preferably one and one-half (1.5) feet in height, but other heights may be chosen as well such as two (2) feet, one (1) foot, one-half (0.5) feet, etc. The body 110 of the transporter 100 is preferably two and one-half (2.5) feet in length, but other lengths may be chosen as well such as two (2) feet, one (1) foot, five (5) feet, etc. The body 110 of the transporter 100 is preferably two (2) feet in depth, but other depths may be chosen as well such as two and one-half (2.5) feet, one (1) foot, five (5) feet, etc.

The body 110 may have a transmission on an internal portion 114 of the body 110. The transmission 112 couples the front-wheel 140 and the back-wheel 130 such that the effort exerted by the operator is minimized. The transmission 112 is preferably automatic but may be manually driven if desired. The body 110 further has a front side 116, a front end 117 and a back-end 118.

An interior portion 114 of the transporter 100 has a plurality of sensors 200 and a computing device 300. The plurality of sensors are preferably coupled significantly near the body 110. The sensors 200 are useful for determining positioning and nearby objects. The sensors 200 are communicatively coupled to the computing device 300. The sensors 200 relay the information determined to the computing device 300. The computing device 300 determines the location of the desired position and directs the front-wheel 140 and the back-wheel 140 to move at a determined speed and direction to properly align the transporter without human intervention. The plurality of sensors 200 are preferably one or more of the following: accelerometer, proximity sensor, position sensor, level sensor, although other types of sensors have also been contemplated and may be used if desired.

The front wheel 140 is coupled to the front end 117 of the body 110 of the transporter 100. The front wheel 140 preferably has two (2) wheels but may have one (1) wheel, three (3) wheels, four (4) wheels, etc. The front-wheel 140 is described in more detail in FIG. 3.

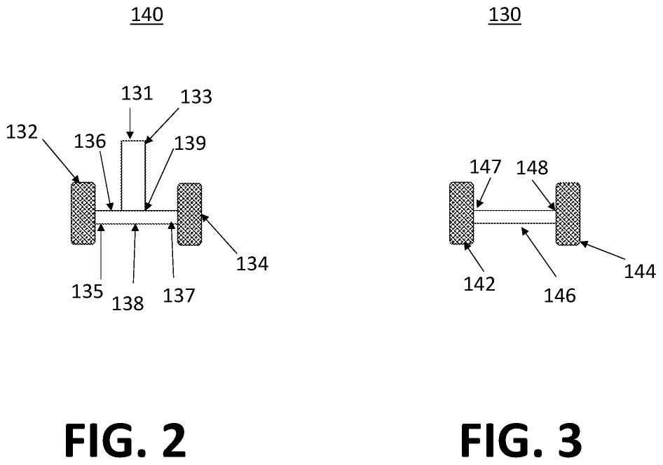

The back-wheel 130 is coupled to the back end 118 of the body 110 of the transporter 100. The back-wheel 140 preferably has two (2) wheels but may have one (1) wheel, three (3) wheels, four (4) wheels, etc. The back-wheel 130 is described in more detail in FIG. 2.

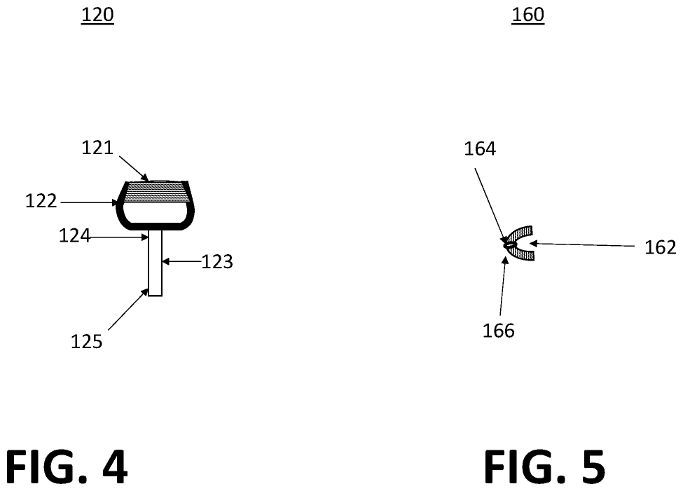

The handle assembly 120 is coupled to the back end 118 of the body 110 and may be coupled to the back-wheel 130. The handle assembly 120 is described in more detail in FIG. 4.

The coupler assembly 150 is useful in coupling to an item to be moved. The item is preferably a food cart, but the item may be any type of item or cargo, such as pallets, cabinets, etc. The coupler assembly 150 has a first end 152 and a second end 154. The first end 152 of the coupler assembly 150 is coupled to the front-side 116 of the body 110 of the transporter 100.

FIG. 2 illustrates and provides more details for the back-wheel 130 of the transporter 100 shown in FIG. 1.

The back-wheel 130 of the transporter 100 has a first wheel 132, a second wheel 134, an axle 136 and a shaft 131. The first wheel 132 of the rear-wheel 130 of the transporter 100 is preferably the same size and type of wheel as the second wheel 134 of the rear-wheel 130 of the transporter 100, but the first wheel 132 of the back-wheel 130 of the transporter 100 may be a different size and/or different type of wheel than the second wheel 134 of the back-wheel 130 of the transporter 100.

The axle 136 of the rear-wheel 130 of the transporter 100 is preferably a cylindrical shape but may be other shapes such as oblong, rectangular, etc. The axle 136 has a first end 135, a second end 137 and a midpoint 138.

The first wheel 132 of the back-wheel 130 of the transporter 100 is coupled to the first end 135 of the axle 136 of the back-wheel 130 of the transporter 100. The second wheel 134 of the back-wheel 130 is coupled to the second end 137 of the axle 136 of the back-wheel 130.

The shaft 131 of the back-wheel 130 of the transporter 100 has a first end 139 and a second end 133. The shaft 131 is preferably cylindrical, but may be square, rectangular, etc. The shaft 131 of the back-wheel 130 of the transporter 100 is preferably made of a metal such as steel, but may be made of other materials such as high-density polyethylene (HDPE), hard plastic, aluminum, etc. The shaft 131 of the back-wheel 130 of the transporter 100 is moveably coupled to the midpoint 138 of the axle 136 of the back-wheel 130 of the transporter 100.

In FIG. 3, the front-wheel 140 of the transporter 100 shown in FIG. 1 is described in more detail. The front-wheel 140 of the transporter 100 has a first wheel 142, a second wheel 144 and an axle 146. The first wheel 142 of the front-wheel 140 is preferably the same size and type of wheel as the second wheel 144 of the front-wheel 140, but the first wheel 142 of the front-wheel 140 may be a different size and/or different type of wheel than the second wheel 144 of the front-wheel 140.

The axle 146 of the front-wheel 140 of the transporter 100 is preferably a cylindrical shape but may be other shapes such as oblong, rectangular, etc. The axle 146 of the front-wheel 140 of the transporter 100 has a first end 147 and a second end 148.

The first wheel 142 of the front-wheel 140 of the transporter 100 is coupled to the first end 147 of the axle 146 of the front-wheel 140 of the transporter 100. The second wheel 144 of the front-wheel 140 is coupled to the second end 148 of the axle 136 of the front-wheel 130 of the transporter 100.

Referring now to FIG. 4, the handle assembly 120 of the transporter 100 shown in FIG. 1 is illustrated in more detail.

The handle assembly 120 of the transporter 100 is useful for steering and controlling the transporter 100. The handle assembly of the transporter 100 has a shaft 123 and a handle 122.

The shaft 123 of the handle assembly 120 of the transporter 100 has a first end 125 and a second end 124. The shaft 123 is preferably cylindrical but may be any shape such as triangular, oblong, square, etc. The shaft 123 of the handle assembly 120 of the transporter 100 is preferably made of a metal such as steel, but may be made of other materials such as high-density polyethylene (HDPE), hard plastic, aluminum, etc.

The first end 125 of the shaft 123 of the handle assembly 120 of the transporter 100 is coupled to the second end 133 of the shaft 131 of the back-wheel 130 of the transporter 100. The shaft 123 of the handle assembly 120 of the transporter 100 and the shaft 131 of the back-wheel 130 of the transporter 100 may be adjustable in length, such that the combination of the shaft 123 of the handle assembly 120 of the transporter 100 and the shaft 131 of the back-wheel 130 of the transporter 100 may be extendable or retractable to create a comfortable position for the operator.

The handle 122 of the handle assembly 120 of the transporter 100 is useful for having a gripping position for the operator of the transporter 100. The handle 122 of the handle assembly 120 of the transporter 100 has a control panel 121. The control panel 121 of the handle 122 of the handle assembly 120 of the transporter 100 has controls which may control a direction such as forward and backward of the transporter, an on/off switch if powered, a shifter for controlling the power of the transporter, etc.

Moving now to FIG. 5, a coupler 160 for coupling an item to the transporter 100 shown in FIG. 1 is now described. The coupler 160 is coupled to the item (not shown) for transport to a first location to a predetermined location.

The coupler 140 has an open end 162 and a closed end 164. The closed end 164 of the coupler 160 has a connector 164. The open end 162 of the coupler 140 is placed around the item and is thereby secured to the item to be transported. The closed end 164 of the coupler 160 is positioned to be aligned with the coupler assembly 150 of the transporter 100. The transporter 100 is moved to toward the coupler 160 and item to be transported. The coupler assembly 150 of the transporter is coupled to the connector 164 of the closed end 166 of the coupler 160 at the second end 154 of the coupler assembly 150 of the transporter 100. The item is then in a condition to be moved to the pre-determined location.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A transporter for transporting wheeled items, the transporter comprising:
a body;
a front wheel, the front wheel being coupled to a front end of the body;
a back-wheel, the back-wheel being coupled a back-end of the body;
a computing device, the computing device being coupled to the interior portion of the transporter;
a plurality of sensors, the sensors being configured on the interior portion of the transporter, wherein the sensors being coupled significantly near the body, and wherein the plurality of sensors being communicatively coupled to the computing device;
a handle, the handle for steering and controlling the transporter, the handle assembly being coupled to the back end of the body; and
a coupler assembly, the coupler assembly being coupled to a front-side of the body, wherein the coupler assembly for coupling to the item to be transported.

2. The transporter of claim 1, wherein the back-wheel further comprising:
an axle, the axle having a midpoint, a first end and a second end;
one or more wheels, wherein a first of the one or more wheels being coupled to a first side of axle, and wherein a second of the one or more wheels being coupled to the second side of the axle; and
a shaft, the shaft being coupled to the midpoint of the axle.

3. The transporter of claim 2, wherein the shaft of the axle having a cylindrical shape.

4. The transporter of claim 2, wherein the first of the one or more wheels being different size than the second of the one or more wheels.

5. The transport of claim 2, wherein the one or more wheels being two (2).

6. The transporter of claim 1, wherein the front wheel further comprising:
an axle, the axle having a first end and a second end; and
one or more wheels, wherein a first of the one or more wheels being coupled to a first side of axle, and wherein a second of the one or more wheels being coupled to the second side of the axle.

7. The transporter of claim 6, wherein the first of the one or more wheels being different size than the second of the one or more wheels.

8. The transporter of claim 6, wherein the one or more wheels being two (2).

9. The transporter of claim 1, wherein the handle assembly further comprises:
a shaft, the shaft being for coupling to the shaft of the axle of the back-wheel; and
a handle, the handle for steering and controlling the transporter.

10. The transporter of claim 9, wherein the shaft being a cylindrical shape.

11. The transporter of claim 9, wherein the handle further comprising a control panel for controlling the transporter.

12. The transporter of claim 9, wherein the shaft being adjustable in length.

13. The transporter of claim 1, further comprising a coupler, the coupler for coupling the item to the coupler assembly of the transporter.

14. The transporter of claim 1, wherein the transporter having a height of one and one-half (1.5) feet.

15. The transporter of claim 1, wherein the transporter having a length of two and one-half (2.5) feet.

16. The transporter of claim 1, wherein the transporter having a depth of two (2) feet.

17. The transporter of claim 1, wherein the plurality of sensors preferably being one or more of: an accelerometer, a proximity sensor, a position sensor, a level sensor.

18. The transporter of claim 1, wherein the transporter being automatically driven.
